(19) United States
(12) Patent Application Publication
(10) Pub. No.: US 2014/0166687 A1
(43) Pub. Date: Jun. 19, 2014

(54) CLAMPING APPARATUS

(71) Applicants: HON HAI PRECISION INDUSTRY CO., LTD., New Taipei (TW); HONG FU JIN PRECISION INDUSTRY (ShenZhen) CO., LTD ., Shenzhen (CN)

(72) Inventors: Zhao-Yong LI, Shenzhen (CN); Wei-Wei WANG, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/889,386

(22) Filed: May 8, 2013

(30) Foreign Application Priority Data
Dec. 17, 2012 (CN) 2012105474236

(51) Int. Cl. G07F 11/68

(52) U.S. Cl. CPC G07F 11/68
USPC 221/26

(57) ABSTRACT

A clamping apparatus for receiving a plurality of objects comprises a base, a limiting mechanism with a pair of limiting plates, and at least one clamping mechanisms secured to one of the limiting plates. The limiting mechanisms are secured to the base and cooperate with the base to form a receiving channel for receiving the objects. Each of the limiting plates comprises a first end. The at least one clamping mechanism is rotatably secured to the first end and clamps the object adjacent to the first end, for allowing the clamped object to be pulled out of the receiving channel. When the clamped object is separated from the at least one clamping mechanism, the at least one clamping mechanism clamps the rest of the objects at the first end.

### BACKGROUND

1. Technical Field

The present disclosure relates to clamping apparatuses, particular to a clamping apparatus for clamping packing cushions.

2. Description of Related Art

Packing cushions for packing an electronic device are piled up together one by one while being stored. When obtaining one of the packing cushions, one hand of an operator pulls the desired packing cushion, and the other hand of the operator grips the rest of packing cushions. However, the two handed-operation is strenuous and may be beyond the capabilities of the physically challenged.

Therefore, there is room for improvement in the art.

### BRIEF DESCRIPTION OF THE FIGURE

The components of the drawings are not necessarily drawn to scale, the emphasis instead being placed upon clearly illustrating the principles of the embodiment of a clamping apparatus. Moreover, in the drawings, like reference numerals designate corresponding parts throughout several views.

FIG. 1 is an isometric view of two parallel clamping apparatuses, according to an embodiment.

FIG. 2 is a partially exploded view of the clamping apparatus of FIG. 1, the clamping apparatus includes a clamping mechanism.

FIG. 3 is partially exploded view of the clamping apparatus of FIG. 1, but viewed from another aspect.

FIG. 4 is an enlarged view of section IV of the clamping apparatus of FIG. 2.

FIG. 5 is an enlarged view of the clamping mechanism of FIG. 2.

FIG. 6 is an exploded view of the clamping mechanism of FIG. 5.

### DETAILED DESCRIPTION

Embodiments of the present disclosure will be described in detail with reference to the drawings.

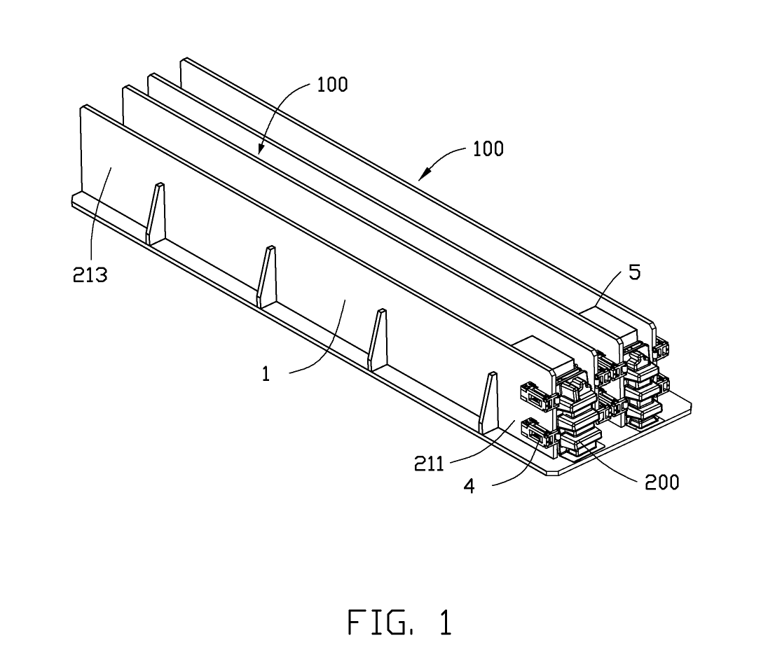

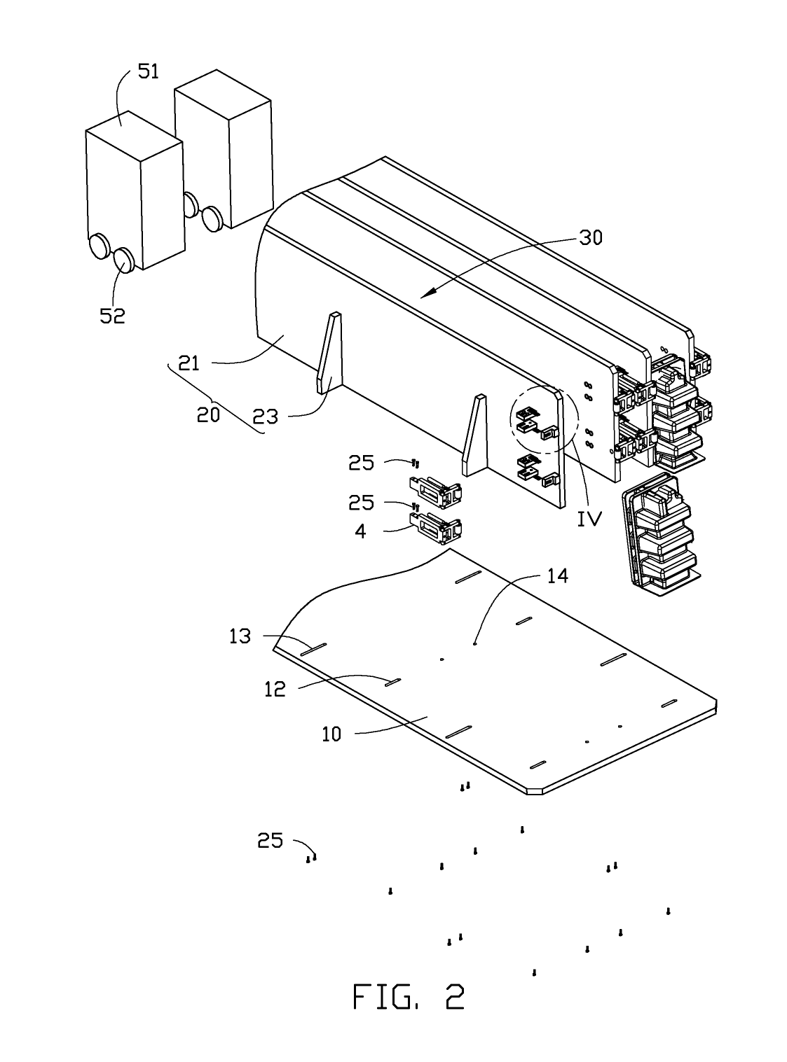

FIGS. 1 and 2 illustrate two parallel clamping apparatus 100 of the embodiment. The clamping apparatus 100 are used for housing a plurality of objects 200, and enable an operator to separates one object 200 from the others. The two clamping apparatuses 100 are combined together, and are arranged parallel to and spaced apart from each other. The objects 200 are piled up together. In the embodiment, the objects 200 are packing cushions for protecting electronic devices stored in a box from damaged during shipping and storage.

Each clamping apparatus 100 includes a housing 1, two pairs of clamping mechanisms 4, and a driving mechanism 5. The clamping mechanisms 4 are symmetrically and evenly secured on opposite sides of the housing 1. The clamping mechanisms 4 of one pair are parallel with each other.

The housing 1 includes a base 10 and a limiting mechanism 20. The base 10 and the limiting mechanism 20 cooperatively define a receiving channel 30. The limiting mechanism 20 is perpendicularly and movably secured on the base 10, to allow the width of the channel 30 to be adjustable for receiving different size of the objects 200. In the embodiment, the bases 10 of the two clamping apparatus 100 are integrally formed together.

The base 10 is substantially rectangular. The base 10 defines a plurality of first sliding slots 12, a plurality of second sliding slots 13 stagger with the first sliding slots 12, and a plurality of through holes 14. Each of the first and second sliding slots 12, 13 extends in a direction perpendicular to the limiting mechanism 20. In the embodiment, the first sliding slots 12 and the second sliding slots 13 are through holes. In the other embodiment, the first sliding slots 12 and the second sliding slots 13 are blind holes which are concaved from the surface of the base 10 facing to the limiting mechanism 20.

Each of the first sliding slots 12 is substantially rectangular and has round corners. Each of two first sliding slots 12 perpendicular to the limiting mechanism 20 and spaced from each other.

Each of the second sliding slots 13 is substantially rectangular and has round corners. The length of the second sliding slot 13 is larger than that of the first sliding slot 12. Each of two second sliding slots 13 perpendicular to the limiting mechanism 20 and spaced from each other. The distance between the second sliding slot 13 and the adjacent edge of the base 10 aligned perpendicular to the limiting mechanism 20 is less than that between the first sliding slot 12 and the same edge of the base 10 aligned perpendicular to the limiting mechanism 20.

There are two through holes 14 defined between the first sliding slots 12 which are perpendicular to the limiting mechanism 20, and are aligned with the corresponding first sliding slots 12. The through holes 14 aligned with the corresponding first sliding slots 12 are spaced from each other.

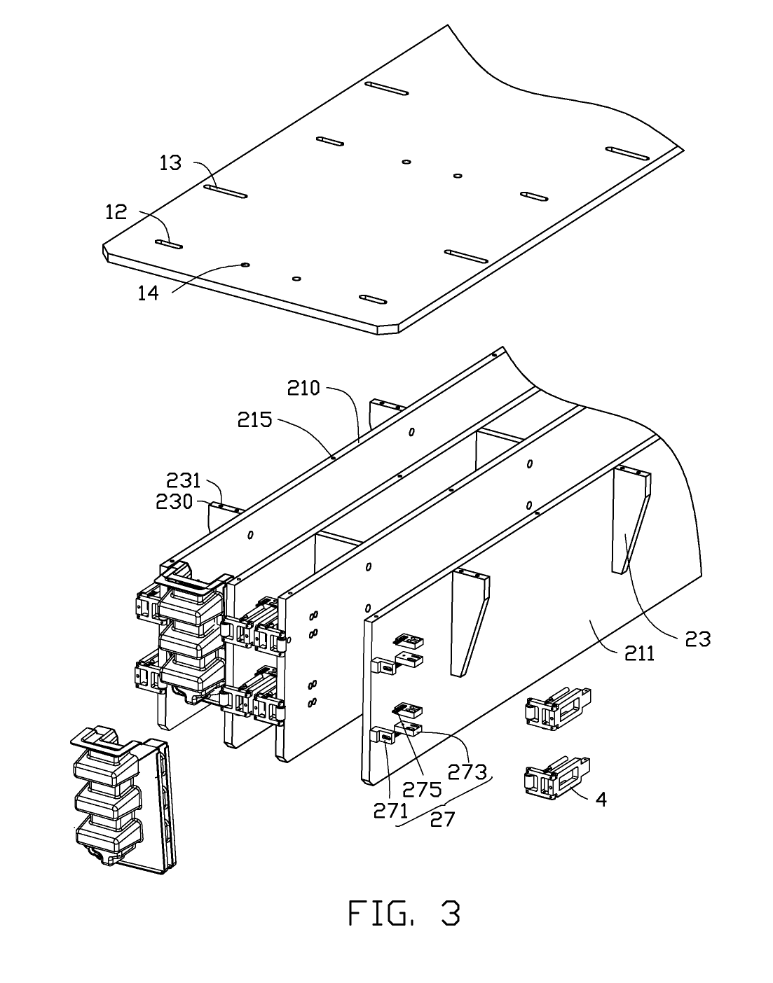

The limiting mechanism 20 includes two limiting plates 21, a plurality of supporting plates 23 corresponding to the second sliding slots 13, a plurality of locking members 25, and two fixing members 27 (see FIG. 3) corresponding to the clamping mechanisms 4. The limiting plates 21 are perpendicularly secured on the base 10 and are spaced apart from each other. One limiting plate 21 is coupled with the first sliding slot 12 and is capable of sliding along the first sliding slot 12 for adjusting the width of the receiving channel 30, and the other limiting plate 21 is coupled with the through holes 14 and is unable to slide. Each limiting plate 21 is substantially rectangular and includes a first end 211, a second end 213 opposite to the first end 211, and a first surface 210 (see FIG. 3) connected between the first end 211 and the second end 213. The first surface 210 faces the base 10 and defines a plurality of fixing holes 215. The inner surface of the fixing hole 215 defines a plurality of screw threads.

FIG. 3 shows that the supporting plate 23 is capable of sliding along the second sliding slot 13. The supporting plate 23 is perpendicularly secured to the outer surface of the limiting plate 21. The supporting plate 23 corresponds to the second sliding slot 13 and is aligned parallel to the limiting plate 21. The supporting plate 23 is substantially right-angled trapeziform shaped. The supporting plate 23 includes a second surface 230 facing the base 10. The second surface 230 is substantially coplanar with the first surface 210 and defines two symmetrically second fixing holes 231 aligned with the corresponding second sliding slot 13. The inner surface of the fixing hole 231 defines a plurality of screw threads.

The locking member 25 (see FIG. 2) is coupled with the limiting mechanism 20 and the clamping mechanism 4. Some of the locking members 25 are respectively secured with first fixing holes 215 via the corresponding first sliding slot 12 for fixing the limiting plate 21 to the base 10. Some of the locking members 25 are respectively secured with the second fixing holes 231 via the corresponding second sliding slot 13 for fixing the supporting plate 23 to the base 10. The rest of the locking members 25 cooperate with the clamping mechanism 4 to fix the clamping mechanism 4 on the fixing member 27. In the embodiment, the locking member 25 is a screw. In other embodiments, the locking members 25 cooperated with the supporting plate 23 so it can be removed for making the supporting plate 23 be inserted into the second sliding slot 13, and the length of the second surface 230 is less than that of the second sliding slot 13.

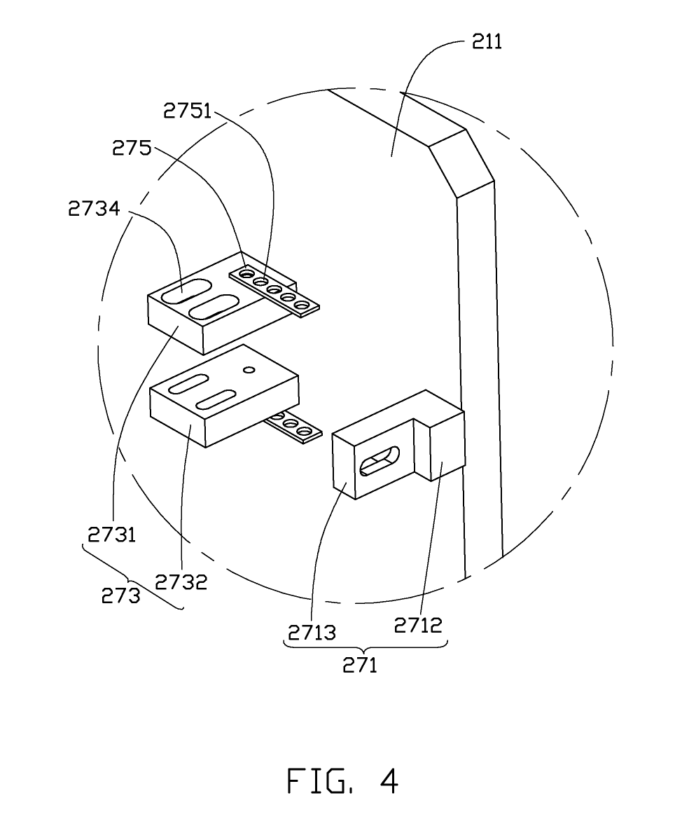

FIG. 4 shows an enlarged view for clearly showing the fixing member 27 of the embodiment. The fixing member 27 includes a supporting portion 271, a blocking portion 273, and at least two first adjusting plates 275. The supporting portion 271 supports the clamping mechanism 4 and is perpendicularly secured to the limiting plate 21. The supporting portion 271 is substantially L-shaped. The supporting portion 271 includes a fixing end 2712 and a resisting end 2713. The fixing end 2712 is substantially rectangular. The end surface of the fixing end 2712 is coplanar with that of the first end 211. The resisting end 2713 perpendicularly extends from the fixing end 2712 in a direction away from the limiting plate 21.

The blocking portion 273 is used for preventing the clamping mechanism 4 from moving along the length of the limiting plate 21. The blocking portion 273 is perpendicularly secured on the limiting plate 21, and is spaced from the supporting portion 271. The blocking portion 273 includes a first plate 2731 and a second plate 2732 parallel to the first plate 2731. The distance between the first plate 2731 and the second plate 2732 is equal to the length of the fixing end 2712. Both of the first plate 2731 and the second plate 2732 define two limiting slots 2734 parallel with each other.

Each adjusting plate 275 is substantially rectangular, and is secured on the outer surface of the first plate 2731 and the second plate 2732, and the other ends of the adjusting plates 275 face the supporting portion 271. Each adjusting plate 275 defines a plurality of adjusting holes 2751. The adjusting holes 2751 are aligned parallel to the limiting plate 21.

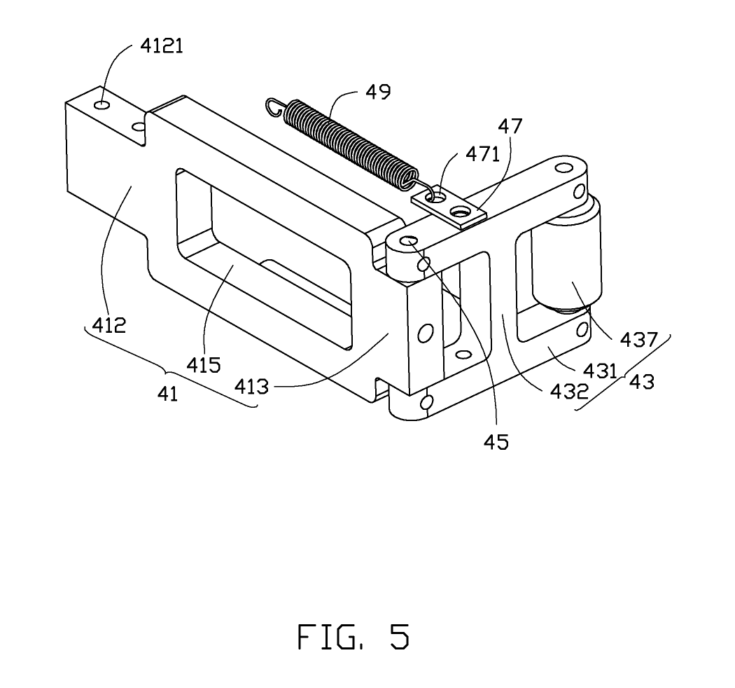

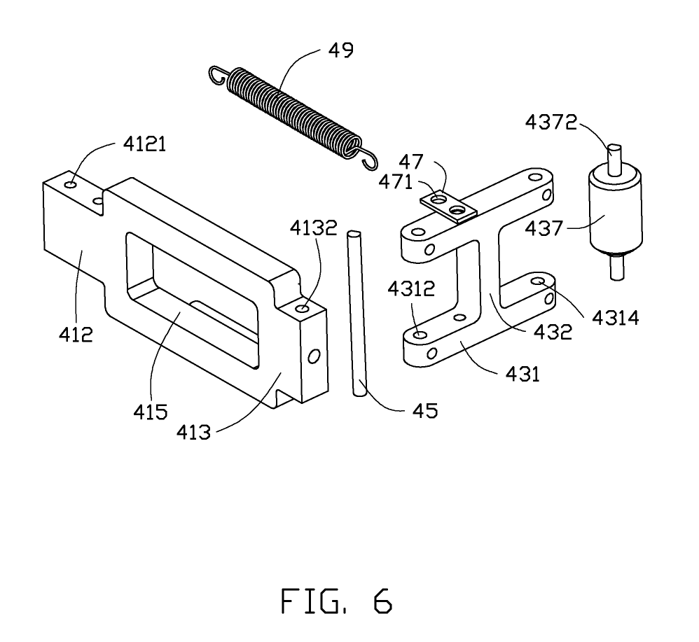

FIGS. 5 and 6 show the clamping mechanism 4 of the embodiment. The clamping mechanism 4 is rotatably secured to the fixing member 27. Each clamping mechanism 4 includes a connecting portion 41, a latching portion 43, a first pivot 45, two second adjusting plate 47 respectively corresponding to the first adjusting plates 275, and two elastic portions 49.

The connecting portion 41 is substantially rectangular and includes a first connecting end 412 and a second connecting end 413 opposite to the first connecting end 412. The first connecting end 412 is inserted into the space between the first plate 2731 and the second plate 2732. The first connecting end 412 defines two third fixing holes 4121 corresponding to the limiting slots 2734. The second connecting end 413 is rotatably coupled to the latching portion 43 and defines a first pivot hole 4132. The middle of the connecting portion 412 further defines an opening 415. The opening 415 is substantially rectangular and is used for receiving the resisting end 2713.

The latching portion 43 is used for preventing the objects 200 from moving out of the receiving channel 30. The latching portion 43 is located at the end surface of the first end 211, and extends in a direction adjacent to the other limiting plate 21. The latching portion 43 is substantially H-shaped. The latching portion 43 includes two first rods 431 parallel to each other, a second rod 432, and a roller 437. The first rod 431 symmetrically defines a second pivot hole 4312 and a third pivot hole 4314 at opposite ends. Opposite ends of the second rod 432 are respectively secured to the middle of the first rods 431. The roller 437 resists and retains the objects 200 at the first end 211 for holding the objects in the receiving channel 30. The roller 437 is substantially cylindrical and includes two second pivots 4372 rotatably received in the second pivot hole 4312. The second pivots 4372 extend from opposite ends of the roller 437 and is coaxial with the roller 437. The diameter of the roller 437 is larger than the width of the first rod 431, and the diameter of the second pivot 4372 is less than that of the roller 437. The second pivots 4372 are respectively inserted into the corresponding second pivot holes 4312 for rotatably securing the roller 437 between the two first rods 431.

The first pivot 45 is used for rotatably connecting the latching portion 43 and the second connecting end 413 via the first pivot hole 4132 and the second pivot hole 4312.

The second adjusting plates 47 are secured to the outer surface of the first rods 431. The second adjusting plate 47 is substantially rectangular and defines a plurality of second adjusting holes 471 spaced from each other. The adjusting holes 471 are arranged in a line along the length of the second adjusting plate 47.

The elastic portion 49 is used for providing elastic force. An end of the elastic portion 49 is movably coupled with one of the first adjusting holes 2751, and the other end of the elastic portion 49 is movably coupled to one of the second adjusting holes 471. The elastic force generated by the deformed elastic portion 49 is adjustable by adjusting the ends of elastic portion 49 to be coupled with different first adjusting holes 2751 or different second adjusting holes 471.

FIG. 2 shows that the driving mechanism 5 is used for driving the objects 200 to move to the first end 211. The driving mechanism 5 includes a main body 51 and at least a pair of symmetrical sliding portions 52. The main body 51 is substantially rectangular. The sliding portions 52 are rotatably secured on the outer surface of the main body 51 and partly protruded out of the main body 51. In the embodiment, the driving mechanism 5 includes two pair of sliding portions 52.

In operation, the objects 200 are completely received in the receiving channel 30, and the two opposite latching portions 43 for retaining the objects 200 in the receiving channel 30 clamp the object 200 at the first end 211. When pulling the clamped object 200 out of the receiving channel 30, all the objects 200 are synchronously moved by the driving mechanism 5, and the latching portions 43 are rotated around the first pivot 45 in reverse directions. The rollers 437 are rotated around the axis of the second pivot 4372. The elastic portions 49 are deformed, when the rollers 437 separate from the clamped object 200, the clamped object 200 is then moved out of the receiving channel 30, and the next object 200 adjacent to the clamped object 200 is moved to the first end 211. Then, the first rods 431 returns to normal position by the elastic force of the elastic portion 49 and clamp the next object 200 at the first end 211. The clamping force for retaining the next objects 200 at the first end 211 is larger than the pull force, thus, the clamped object 200 can be separated from the rest of the objects 200.

As described, the objects 200 are received and clamped by the clamping apparatus 100, the object 200 clamped by the clamping apparatus 100 can easily being peeled from the rest of the objects 200 by single hand. Therefore, the pasting operation is improved.

While various exemplary and preferred embodiments have been described, the disclosure is not limited thereto. On the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. A clamping apparatus for receiving a plurality of objects, the clamping apparatus comprising:
a base;
a limiting mechanism, comprising a pair of limiting plates secured to the base, the limiting plates cooperating with the base to form a receiving channel for receiving the objects; and
at least one clamping mechanism secured on one of the limiting plates;
wherein each of the limiting plate comprises a first end; the at least one clamping mechanism is rotatably secured at the first end and clamps the object adjacent to the first end, for allowing the clamped object to be pulled out of the receiving channel, when the clamped object is separated from the at least one clamping mechanism, the at least one clamping mechanism clamps the rest of the objects at the first end.

2. The clamping apparatus of claim 1, wherein the two limiting plates are capable of moving away from each other to adjust the width of the receiving channel for receiving different size of objects.

3. The clamping apparatus of claim 2, wherein the limiting mechanism further comprises a plurality of locking members; the base defines a plurality of first sliding slots and a plurality of through holes corresponding to the first sliding slots; the first sliding slot and the corresponding through hole are aligned perpendicular to the limiting plates; the bottom surface of the limiting plate faces the base and defines a plurality of first fixing holes; one of the limiting plates is coupled with the first sliding slots and is capable of sliding along the first sliding slot for adjusting the width of the receiving channel, the other limiting plate is coupled with the through hole; some of the locking member are screwed with the first fixing holes via the corresponding first sliding slot or the corresponding through hole to locate the position of the limiting plate.

4. The clamping apparatus of claim 3, wherein the base further defines a plurality of second sliding slots; the limiting mechanism further comprises a plurality of supporting plates corresponding to the second sliding slot; the supporting plates are perpendicular to the outer surface of the limiting plate; the second sliding slots are stagger and parallel with the first sliding slots; the supporting plate is coupled with the corresponding second sliding slot and capable of sliding along the second sliding slot.

5. The clamping apparatus of claim 4, wherein, the bottom surface of the supporting plate is substantially coplanar with the bottom surface of the limiting plate, and defines a plurality of second fixing holes; some of the locking member are screwed in the second fixing holes via the corresponding second sliding slot to locate the position of the supporting plate.

6. The clamping apparatus of claim 4, wherein the supporting plate is inserted into the corresponding second sliding slot and capable of sliding in the second sliding slot.

7. The clamping apparatus of claim 1, wherein the limiting mechanism further comprises a fixing member for securing the clamping mechanism at the first end; the fixing member comprises a supporting portion and a blocking portion; the supporting portion and the blocking portion are secured to the outer surface of the limiting plate; the supporting portion is adjacent to the first end; the blocking portion is spaced from the supporting portion and away from the first end; an end of the clamping mechanism is inserted into the blocking portion, and an end of the supporting portion is inserted into the clamping mechanism.

8. The clamping apparatus of claim 7, wherein the clamping mechanism comprises a connecting portion secured to the fixing member and a latching portion perpendicular to the connecting portion; the connecting portion connects the blocking portion and the latching portion; an end of the latching portion is located at the end surface of the first end extending to the opposite first end, and the other end of the latching portion is rotatably coupled with the connecting portion.

9. The clamping apparatus of claim 8, wherein the distance between the two corresponding latching portions are less than that between the two corresponding limiting plates.

10. The clamping apparatus of claim 8, wherein the blocking portion comprises a first plate and a second plate; the connecting portion comprises a first connecting end and a second connecting end; the first connecting end and the second connecting end are located at opposite ends of the connecting portion; the distance between the first plate and the second plate cooperate to block the first connecting end for preventing the latching portion from moving along a direction perpendicular to the base.

11. The clamping apparatus of claim 8, wherein the connecting portion defines an opening in the middle of the connecting portion; the supporting portion is inserted into the opening for preventing the latching portion from moving to the first end.

12. The clamping apparatus of claim 8, wherein the clamping mechanism further comprises a first pivot; the second connecting end defines a first pivot hole; the latching portion comprises two parallel first rod and a second rod; opposite ends of the second rod is respectively secured to the middle of the first rods; the first rod defines a second pivot hole; the firs pivot via the first pivot hole and the second pivot hole rotatably connect the second connecting end and the latching portion.

13. The clamping apparatus of claim 8, wherein the latching portion further comprise a roller; the first rod further defines a third pivot hole which is symmetrically at the opposite ends of the first rod; the two ends of the roller are respectively inserted into the two third pivot hole of the first rod.

14. The clamping apparatus of claim 13, wherein the roller is substantially cylindrical and comprises two second pivots corresponding to the second pivot hole; the second pivots are extended from the opposite bottom surfaces around the axis of the roller; the diameter of the roller is larger than the width of the first rod.

15. The clamping apparatus of claim 8, wherein the fixing member further comprises a pair of first adjusting plates; the clamping mechanism further comprises two elastic portions corresponding to the first adjusting plates; the first adjusting plates are secured to the blocking portion; the first adjusting plates defines a plurality of adjusting holes; the elastic portions are capable of coupling with one of the first adjusting holes to provide different elastic force.

16. A clamping apparatus comprising:
a base;
a pair of limiting plates secured to the base and cooperated with the base to form a receiving channel;
at least one fixing member respectively secured to the limiting plates; and
at least one clamping mechanism mounted on the corresponding fixing member;
wherein the clamping mechanism comprises a connecting portion and a latching portion; an end of the connecting portion is inserted into the fixing member, and the other end of the connecting portion is rotatably connected with the latching portion, the latching portions is located on the end surface of the limiting plate where the fixing member is secured to and extends to the other limiting plate; the latching portion clamps objects in the receiving channel; one of the limiting plates are capable of moving in a direction perpendicular to the limiting plate to adjust the width of the receiving channel for receiving different size of objects.

17. The clamping apparatus of claim 16, wherein the clamping apparatus further comprises a driving mechanism; the driving mechanism is used for driving the received objects to move to the first end when the latching portion is rotated.

18. The clamping apparatus of claim 16, wherein the clamping mechanism further comprises at least one elastic portion; two opposite ends of the elastic portion are respectively connected to the fixing member and the latching portion corresponding to the fixing member; when the latching portions rotate along two opposite directions which are parallel with the base by an external force, the elastic portion is deformed to generate an elastic force for resuming the corresponding latching portion to the normal position when the external force is removed.

19. The clamping apparatus of claim 18, wherein the fixing member further comprises at least one first adjusting plate; the first adjusting plate is secured to the fixing portion; the first adjusting plates defines a plurality of first adjusting holes; the elastic portion is capable of coupling with one of the first adjusting holes to provide different elastic force.

20. The clamping apparatus of claim 17, wherein the clamping mechanism further comprises a second adjusting plate; the second adjusting plate is mounted on the latching portion; the second adjusting plates defines a plurality of second adjusting holes; an end of the elastic portion is secured to the fixing member, and the other end of the elastic portion is inserted into one of the second adjusting holes; the elastic portion is capable of coupling with one of the second adjusting holes to provide different elastic force.
